(19) United States
(12) Patent Application Publication
(10) Pub. No.: US 2024/0337829 A1
(43) Pub. Date: Oct. 10, 2024

(54) DESIGN OF PHOTONIC SUPER-GATES

(71) Applicant: Milkshake Technology Inc., Menlo Park, CA (US)

(72) Inventors: Bicky A. Marquez, Kingston (CA); Ahmed Khaled, Kingston (CA); Orad Reshef, Ottawa (CA); Joshua S.J. Baxter, Ottawa (CA); Bhavin J. Shastri, Kingston (CA); Douglas H. Wightman, Kingston (CA)

(21) Appl. No.: 18/436,415

(22) Filed: Feb. 8, 2024

Related U.S. Application Data
(60) Provisional application No. 63/456,956, filed on Apr. 4, 2023.

(51) Int. Cl. G02B 27/00; G02F 3/00

(52) U.S. Cl. CPC G02B 27/0012; G02F 3/00

(57) ABSTRACT

Embodiments are directed to designing area and power-efficient photonic super-gates. A first modeling circuit of an emulator circuit generates a physical model for a photonic circuit having a plurality of cascaded photonic gates, based on a set of photonic input signals and a set of one or more photonic output signals that are defined in accordance with a truth table of the photonic circuit. Based on the physical model, a first optimizer circuit of the emulator circuit estimates initial parameters of a target model for the photonic circuit. A second modeling circuit of the emulator circuit generates, based on the initial parameters, a set of parameters of the target model. A second optimizer circuit of the emulator circuit executes a design algorithm on the set of parameters of the target model to instantiate a photonic super-gate that emulates operations of the photonic circuit.

### CROSS-REFERENCE TO RELATED APPLICATIONS

This application claims a benefit and priority to U.S. Provisional Patent Application Ser. No. 63/456,956, filed on Apr. 4, 2022, which is hereby incorporated by reference in its entirety.

### TECHNICAL FIELD

The present disclosure generally relates to a processor architecture and, more specifically, to design of photonic super-gates.

### BACKGROUND

Photonic hardware is favorable for applications requiring high bandwidth, low latency, and low switching energy for signal processing, data communications, and information processing (i.e., computing). Recent innovations in silicon photonic fabrication have enabled the on-chip implementation of photonic circuits. This has opened a low-cost, high-precision, and scalable avenue for the development of photonic computing. Advances in photonic computing have demonstrated suitability for applications requiring high-bandwidth parallel processing, especially neural networks, offering higher speed and less energy consumption than equivalent networks implemented in digital or analog electronics. However, designing more complex photonic gates (e.g., photonic circuits with cascaded photonic gates) that implement larger truth tables remains a challenge.

### SUMMARY

Embodiments of the present disclosure are directed to designing area-efficient and power-efficient photonic super-gates. The design (i.e., instantiation) of photonic super-gates presented herein may be performed by an emulator circuit. The emulator circuit includes a first modeling circuit, a first optimizer circuit coupled to the first modeling circuit, a second modeling circuit coupled to the first optimizer circuit, and a second optimizer circuit coupled to the second modeling circuit. The first modeling circuit is configured to generate a plurality of parameters of a physical model for a photonic circuit having a plurality of cascaded photonic gates, based on a set of photonic input signals and a set of one or more photonic output signals that are defined in accordance with a truth table of the photonic circuit. The first optimizer circuit is configured to estimate, based on the plurality of parameters of the physical model, a plurality of initial parameters of a target model for the photonic circuit. The second modeling circuit is configured to generate, based on the plurality of initial parameters, a plurality of parameters of the target model. The second optimizer circuit is configured to execute a design algorithm using the plurality of parameters of the target model to instantiate a photonic super-gate emulating operations of the photonic circuit having the plurality of cascaded photonic gates.

Embodiments of the present disclosure are further directed to a non-transitory computer-readable storage medium comprising stored instructions that, when executed by at least one processor of an emulator circuit, cause the at least one processor to: instruct a first modeling circuit of the emulator circuit to generate a plurality of parameters of a physical model for a photonic circuit having a plurality of cascaded photonic gates, based on a set of photonic input signals and a set of one or more photonic output signals that are defined in accordance with a truth table of the photonic circuit; instruct a first optimizer circuit of the emulator circuit coupled to the first modeling circuit to estimate, based on the plurality of parameters of the physical model, a plurality of initial parameters of a target model for the photonic circuit; instruct a second modeling circuit of the emulator circuit coupled to the first optimizer circuit to generate, based on the plurality of initial parameters, a plurality of parameters of the target model; and instruct a second optimizer circuit of the emulator circuit coupled to the second modeling circuit to execute a design algorithm using the plurality of parameters of the target model to instantiate a photonic super-gate emulating operations of the photonic circuit having the plurality of cascaded photonic gates. The non-transitory computer-readable storage medium can be a digital storage medium, an analog storage medium, an optical storage medium, some other type of storage medium, or some combination thereof. The at least one processor can be an optical processor, an electronic processor (e.g., central processing unit (CPU) processor, machine learning (ML) processor, artificial intelligence (AI) processor, and/or graphics processing unit (GPU) processor), some other type of processor, or some combination thereof.

Embodiments of the present disclosure are further directed to a method performed by an emulator circuit for designing a nonlinear photonic super-gate. The method comprises: generating, by a first modeling circuit of the emulator circuit, a plurality of parameters of a physical model for a photonic circuit having a plurality of cascaded photonic gates, based on a set of photonic input signals and a set of one or more photonic output signals that are defined in accordance with a truth table of the photonic circuit; estimating, by a first optimizer circuit of the emulator circuit coupled to the first modeling circuit, a plurality of initial parameters of a target model for the photonic circuit based on the plurality of parameters of the physical model; generating, by a second modeling circuit of the emulator circuit coupled to the first optimizer circuit, a plurality of parameters of the target model based on the plurality of initial parameters; and executing, by a second optimizer circuit of the emulator circuit coupled to the second modeling circuit, a design algorithm on the plurality of parameters of the target model to instantiate a photonic super-gate emulating operations of the photonic circuit having the plurality of cascaded photonic gates.

### BRIEF DESCRIPTION OF THE DRAWINGS

FIG. 1A illustrates an example two-input logic gate and a corresponding truth table, in accordance with some embodiments.

FIG. 1B illustrates an example two-input linear photonic gate and a corresponding truth table, in accordance with some embodiments.

FIG. 2 illustrates an example photonic circuit with cascaded linear photonic gates, in accordance with some embodiments.

FIG. 3 illustrates an example linear photonic super-gate, in accordance with some embodiments.

FIG. 4A illustrates an example process of designing a linear photonic super-gate, in accordance with some embodiments.

FIG. 4B illustrates an example system architecture for an emulator circuit used for designing the linear photonic super-gate of FIG. 4A, in accordance some embodiments.

FIG. 5A illustrates an example two-input nonlinear photonic gate, in accordance with some embodiments.

FIG. 5B illustrates an example nonlinear photonic super-gate, in accordance with some embodiments.

FIG. 6 illustrates an example nonlinear photonic circuit with cascaded photonic super-gates, in accordance with some embodiments.

FIG. 7 illustrates an example nonlinear cascaded photonic circuit implemented with linear optics, in accordance with some embodiments.

FIG. 8 illustrates an example nonlinear photonic circuit with a nonlinear photonic super-gate, in accordance with some embodiments.

FIG. 9A illustrates an example process of designing a nonlinear photonic super-gate, in accordance with some embodiments.

FIG. 9B illustrates an example system architecture for an emulator circuit used for designing the nonlinear photonic super-gate of FIG. 9A, in accordance some embodiments.

FIG. 10 is a flowchart illustrating an example method for instantiating a nonlinear photonic super-gate at an emulator circuit, in accordance with some embodiments.

The figures depict embodiments of the present disclosure for purposes of illustration only. One skilled in the art will readily recognize from the following description that alternative embodiments of the structures and methods illustrated herein can be employed without departing from the principles or benefits touted by the disclosure described herein.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that can be employed without departing from the principles of what is claimed.

Reference will now be made in detail to several embodiments, examples of which are illustrated in the accompanying figures. It is noted that wherever practicable, similar or like reference numbers can be used in the figures and can indicate similar or like functionality. The figures depict embodiments of the disclosed system (or method) for illustration only. One skilled in the art will readily recognize from the following description that alternative embodiments of the structures and methods illustrated herein can be employed without departing from the principles described herein.

Embodiments of the present disclosure are directed to an efficient design of photonic super-gates that implement larger truth tables. A single photonic super-gate implements operations of cascaded photonic gates. A physical model of a photonic circuit shaped by a corresponding truth table may be initially designed and input into a numerical optimizer circuit. The numerical optimizer circuit may estimate parameters (e.g., scattering parameters, transfer parameters, etc.) for a target model, and output a parametrized target model that serves as a reference to design the photonic super-gate. An optimization algorithm may be then applied to design the photonic super-gate. Sets of photonic input signals and photonic output signals defined in accordance with the truth table can be further provided as inputs into the numerical optimizer circuit so that a library of cells for a corresponding photonic super-gate is generated. The design process presented herein results in an area-efficient and power-efficient photonic super-gate.

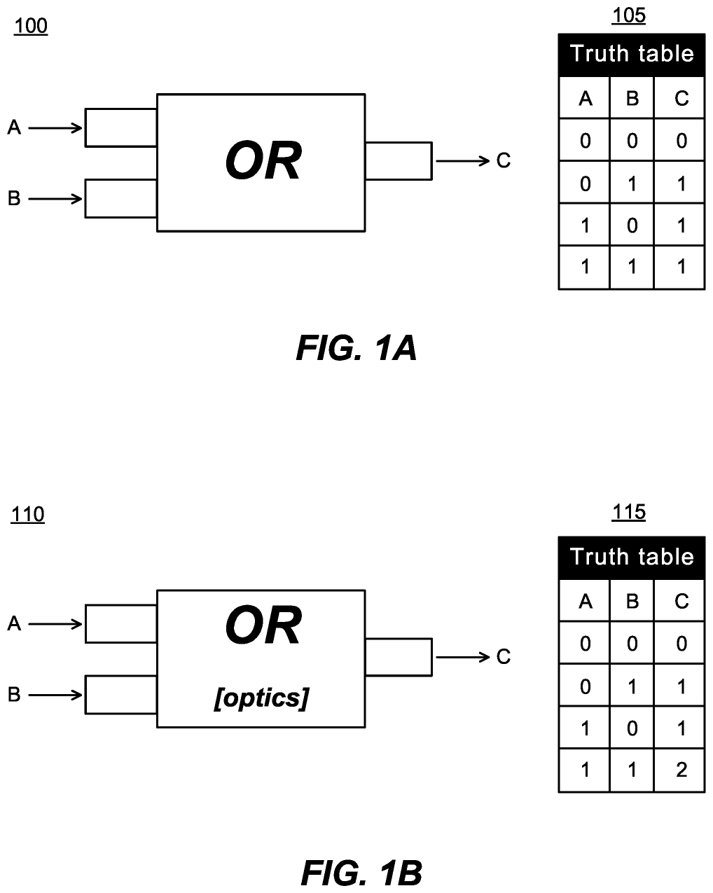

FIG. 1A illustrates an example two-input logic gate 100 and a corresponding truth table 105, in accordance with some embodiments. The two-input logic gate 100 may be an example target linear photonic gate that operates in accordance with the truth table 105. The two-input logic gate 100 may operate as, e.g., a two-input OR gate. The two-input logic gate 100 may be a linear photonic gate that receives a pair of inputs A and B, and generates a corresponding output C in accordance with the truth table 105.

FIG. 1B illustrates an example two-input photonic gate 110 with a corresponding truth table 115, in accordance with some embodiments. The two-input photonic gate 110 may be an optical implementation of the two-input logic gate 100. The two-input photonic gate 110 may operate as, e.g., a linear two-input photonic OR gate in accordance with the truth table 115. The linear photonic gate 110 may receive a pair of photonic input signals A and B, and generate a corresponding photonic output signal C in accordance with the truth table 115. The photonic input signals A and B may be light signals of corresponding input amplitudes (that each corresponds to logical “1” or logical “0”), corresponding input phases and/or corresponding input modes (i.e., input light spatial distribution and/or input wavelengths) injected into a set of input ports of the linear photonic gate 110. The set of input ports of the linear photonic gate 110 may represent, e.g., a set of waveguides, a set of waveguide polarizations, a set of waveguide modes, a set of light wavelengths, etc.

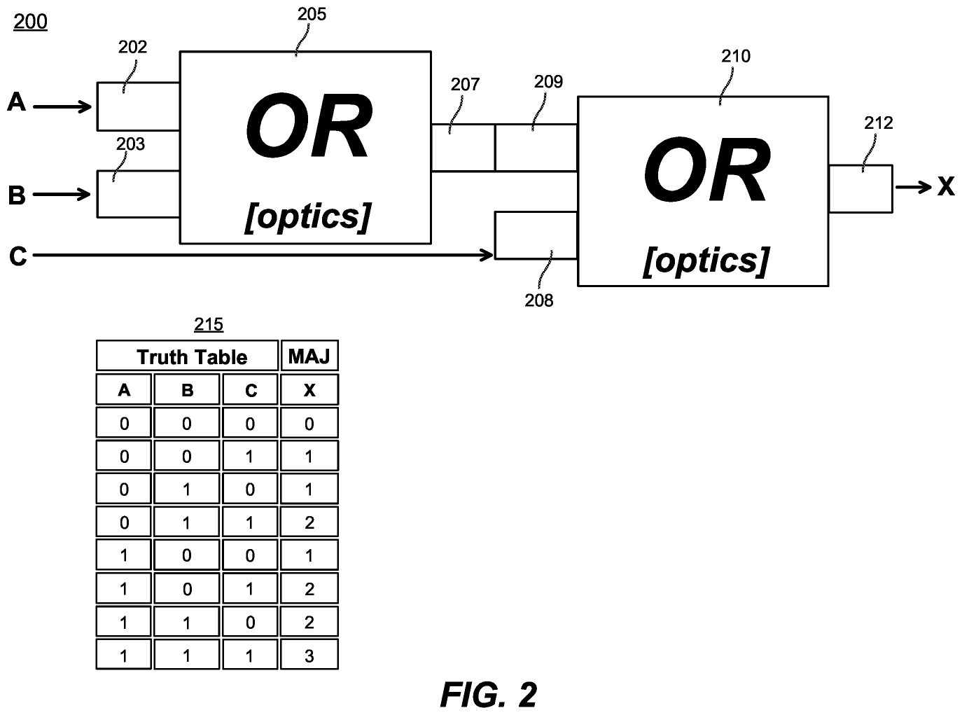

The photonic output signal C generated by the linear photonic gate 110 may be a light signal of a corresponding output amplitude (which corresponds to logical “1” or logical “0”) detected at an output port of the linear photonic gate 110. When the linear photonic gate 110 operates as a linear OR photonic gate in accordance with the truth table 115, an output amplitude of the photonic output signal C that is less than 1 represents logical “0”, and an output amplitude of the photonic output signal C that is greater than or equal to 1 represents logical “1”. The output port of the linear photonic gate 110 may represent, e.g., a waveguide, a waveguide polarization, a waveguide mode, a light wavelength, a signal radiated by the linear photonic gate 110, etc. Multiple linear photonic gates 110 may be cascaded to form a single linear photonic circuit that operates in accordance with a larger truth table, as discussed further bellow in relation to FIG. 2.

FIG. 2 illustrates an example photonic circuit 200 with cascaded linear photonic gates, in accordance with some embodiments. The photonic circuit 200 may include a first linear photonic gate 205 (e.g., first OR photonic gate) cascaded to a second linear photonic gate 210 (e.g., second OR photonic gate). Each of the first linear photonic gate 205 and the second linear photonic gate 210 may be an embodiment of the OR photonic gate 110. The cascaded photonic circuit 200 may receive three independent photonic input signals, A, B, and C, and generate a photonic output signal X of a corresponding amplitude in accordance with a truth table 215. The photonic input signals A and B may be injected into input ports 202 and 203 of the first linear photonic gate 205, and the photonic input signal C may be injected into an input port 208 of the second linear photonic gate 210. The input ports 202, 203 and 208 may represent input ports of the cascaded photonic circuit 200. When the first linear photonic gate 205 and the second linear photonic gate 210 both operate as OR photonic gates, the cascaded photonic circuit 200 may operate as the three-input MAJ (majority) circuit.

As shown in FIG. 2, an output port 207 of the first linear photonic gate 205 may be directly connected to an input port 209 of the second linear photonic gate 210. A photonic output signal of the first linear photonic gate 205 generated at the photonic output port 207 may be directly input into the photonic input port 209 of the second linear photonic gate 210. In this manner, two cascaded linear photonic gates 205, 210 may form the cascaded photonic circuit 200 representing a three-input circuit (e.g., three-input MAJ circuit) that operates in accordance with the truth table 215 larger than a truth table of individual linear photonic gates (e.g., larger than the truth table 115). The photonic output signal X detected at an output port 212 of the second linear photonic gate 210 may be a light signal of a corresponding output amplitude (which corresponds to logical “1” or logical “0”). The output port 212 may represent an output port of the cascaded photonic circuit 200. When the cascaded photonic circuit 200 operates as the three-input MAJ photonic gate in accordance with the truth table 215, an output amplitude of the photonic output signal X that is less than 2 represents logical “0”, and an output amplitude of the photonic output signal X that is greater than or equal to 2 represents logical “1”.

It should be noted that all photonic connections within the photonic circuit 200 (including input and output ports) may be implemented as silicon waveguides. The photonic gates 205, 210 may be implemented as silicon photonic circuits. When thresholders (i.e., nonlinear photonic circuits) are connected at outputs of the photonic gates 205, 210 to correct for any phase and/or amplitude errors, these nonlinear photonic circuits may be implemented in a III-V platform containing an alloy composed of semiconductors from groups III and V in the periodic table (e.g., InP, InAs, GaAs, GaN, and InSb) using a saturated absorber, SOA, saturated gain, or some combination thereof. In such cases, the nonlinear photonics circuits may be heterogeneously integrated with silicon photonic circuits (e.g., the photonic gates 205, 210) of the photonic circuit 200. Alternatively, the nonlinear photonic circuits of the photonic circuit 200 may be implemented with electro-optical devices such as photodetectors, modulators, complementary metal-oxide-semiconductor transimpedance amplifiers (CMOS TIAs), and any other element that improves the design. In such cases, the nonlinear photonic circuits may be CMOS monolithically integrated with silicon photonic circuits (e.g., the photonic gates 205, 210) of the photonic circuit 200. Alternatively or additionally, the nonlinear photonic circuits may also be fiber attached, micro-transfer printed, flip-chipped, optically and/or electronically wire-bonded to other components of the photonic circuit 200.

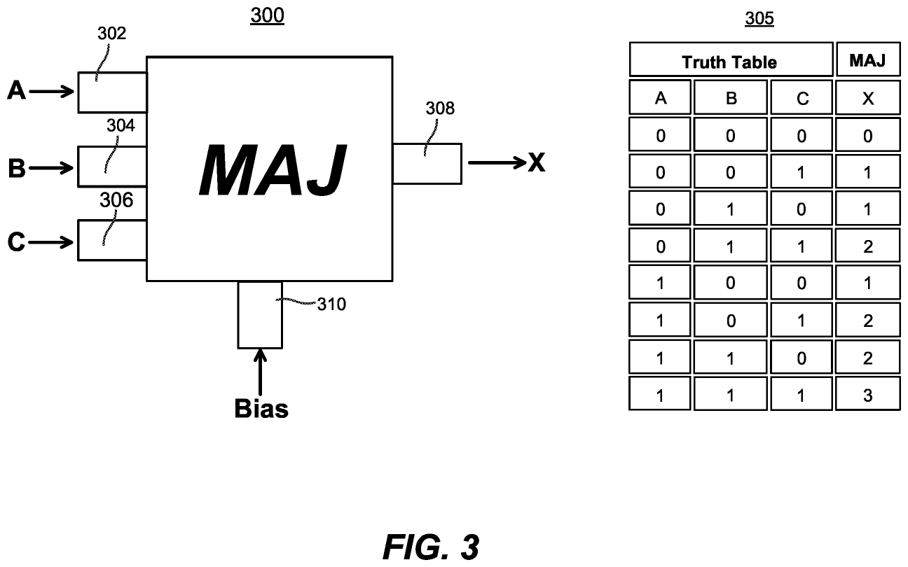

FIG. 3 illustrates an example linear photonic super-gate 300, in accordance with some embodiments. The linear photonic super-gate 300 may perform the same operations as the linear cascaded photonic circuit 200. The linear photonic super-gate 300 may represent a single photonic gate that implements operations of multiple cascaded photonic gates (e.g., the OR photonic gates 205, 210) and generate a photonic output signal in accordance with a truth table 305. The linear photonic super-gate 300 may thus operate as, e.g., the three-input MAJ photonic gate in accordance with the truth table 305 (which is identical to the truth table 215). Photonic signals A, B and C may be input into the linear photonic super-gate 300, and a photonic output signal X may be generated by the linear photonic super-gate 300 in accordance with the truth table 305.

The photonic signals A, B and C input into the linear photonic super-gate 300 may be light signals of corresponding input amplitudes (that each corresponds to logical “1” or logical “0”) injected into a set of input ports 302, 304, 306 of the linear photonic super-gate 300. The set of input ports 302, 304, 306 of the linear photonic super-gate 300 may represent, e.g., a set of waveguides, a set of waveguide polarizations, a set of waveguide modes, a set of light wavelengths, etc. The photonic output signal X detected at an output port 308 of the linear photonic super-gate 300 may be a light signal of a corresponding output amplitude (which corresponds to logical “1” or logical “0”). When the linear photonic super-gate 300 operates as the three-input MAJ photonic gate, an output amplitude of the photonic output signal X that is less than 2 represents logical “0”, and an output amplitude of the photonic output signal X that is greater than or equal to 2 represents logical “1”. The output port 308 of the linear photonic super-gate 300 may represent, e.g., a waveguide, a waveguide polarization, a waveguide mode, a light wavelength, a signal radiated by the linear photonic super-gate 300, etc. As shown in FIG. 3, the linear photonic super-gate 300 may further include a bias port 310 for inputting a bias signal (“Bias”). The bias port 310 of the linear photonic super-gate 300 may represent, e.g., a waveguide, a waveguide polarization, a waveguide mode, a light wavelength, etc. The bias signal may be a light signal of a defined amplitude level that is constant over time. The bias signal may be generated by, e.g., a photonic local source coupled to the bias port 310 (not shown in FIG. 3).

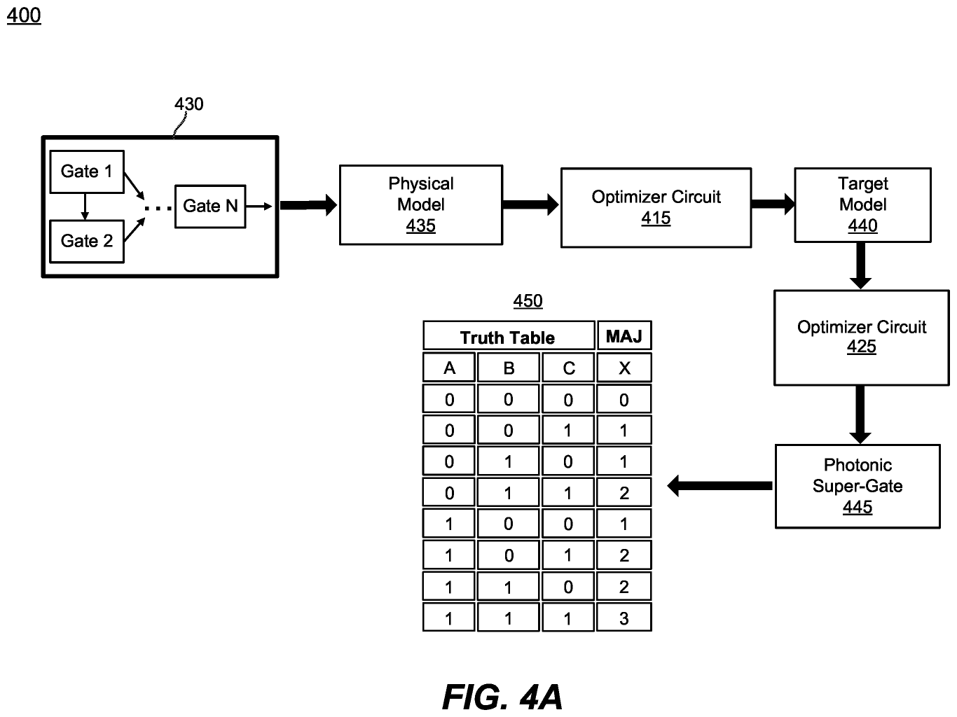

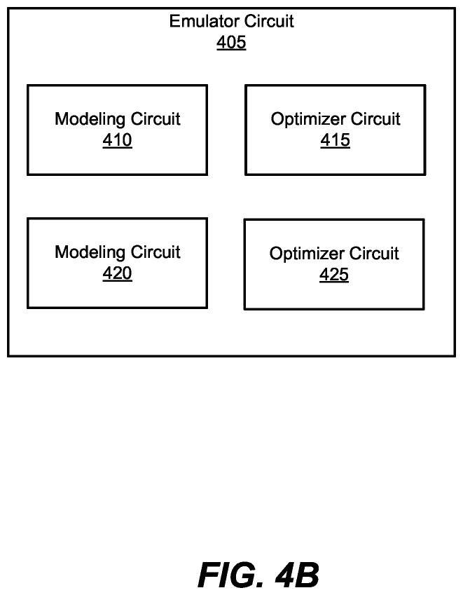

Details about the designing of area-efficient and power-efficient linear photonic super-gates (e.g., the linear photonic super-gates 200 and 300) are provided below in relation to FIGS. 4A-4B.

FIG. 4A illustrates an example process 400 of designing a linear photonic super-gate, in accordance with some embodiments. The process 400 may be executed by components of an emulator circuit 405 shown in FIG. 4B. The emulator circuit 405 may include a modeling circuit 410, an optimizer circuit 415 having a set of one or more inputs directly connected to a set of one or more outputs of the modeling circuit 410, a modeling circuit 420 having a set of one or more inputs directly connected to a set of one or more outputs of the optimizer circuit 415, and an optimizer circuit 425 having a set of one or more inputs directly connected to a set of one or more outputs of the modeling circuit 420. The emulator circuit 405 may include additional components not shown in FIG. 4B. Alternatively, some components of the emulator circuit 405 may be combined into a single module for performing multiple operations. In some embodiments, the emulator circuit 405 is deployed in a computing system that can further include one or more processors and a non-transitory computer-readable storage medium (e.g., optical, electrical, or electro-optical memory) for storing computer-executable instructions and data for and executable by the one or more processors (and corresponding memory) to perform the process 400 as described. The computing system as noted also may be used with other processes as disclosed herein.

The goal is to design a single linear photonic super-gate that is area-efficient and power-efficient and performs the same operations as a target photonic circuit 430 with cascaded photonic gates. Note that the target photonic circuit 430 may include a series of cascaded photonic gates (e.g., N cascaded photonic gates, where N≥2). Initially, the modeling circuit 410 may generate, using a truth table of the photonic circuit 430, a set of parameters of a physical model 435 for the photonic circuit 430. The set of parameters of the physical model 435 may be passed onto the optimizer circuit 415. The optimizer circuit 415 may apply a numerical optimization algorithm on the set of parameters of the physical model 410 to estimate an initial set of parameters (e.g., scattering parameters and/or transfer parameters) of a target model 440 for the photonic circuit 430. To estimate the initial set of parameters of the target model 440, the optimizer circuit 415 may apply the inverse design that utilizes finite-difference time-domain (FDTD) simulations, finite-difference frequency-domain (FDFD) simulations, machine learning algorithm, artificial intelligence-based algorithm, any other suitable numerical optimization algorithm, or some combination thereof.

Note that for a given photonic circuit with photonic inputs and photonic outputs (e.g., for the target photonic circuit 430), a scattering matrix with scattering parameters (or complex coefficients) defines the relations between corresponding photonic inputs and corresponding photonic outputs. A transfer function with transfer parameters defines the absolute value of the relations between photonic inputs and photonic outputs of the photonic circuit. Note also that photonic input signals and photonic output signals of the target photonic circuit 430 are known. However, to design a photonic super-gate that performs the same operations as the target photonic circuit 430 with cascaded photonic gates, it may be required to calculate target coefficients (e.g., scattering parameters and/or transfer parameters) based on the target output. The optimizer circuit 415 may generate the target coefficients by, e.g., iteratively updating device coefficients of a device S-matrix representation model of the target photonic circuit 430 based on a comparison between the device coefficients and the target coefficients to determine a final version of the device coefficients. The initial set of parameters (e.g., scattering parameters and/or transfer parameters) of the target model 440 may be passed onto the modeling circuit 420.

In one or more embodiments, the optimizer circuit 415 instantiates a library of cells for a linear photonic super-gate based on a set of photonic inputs and a set of one or more photonic outputs defined by the truth table of the photonic circuit 430 that are input into the optimizer circuit 415. Each cell may be designed using an optimization algorithm (e.g., FDTD-based optimization algorithm, FDFD-based optimization algorithm, machine learning algorithm, artificial intelligence-based algorithm, etc.). After that, the target output (e.g., truth table) may be compared with the actual output of the cell to ensure correct functionality of the cell. Once all cells are designed, the cells may be cascaded by plugging the cells to each other via waveguides. Additionally, thresholders may be included in between the output of one cell and the input of the next cascaded cell to correct for any phase and/or amplitude error.

The modeling circuit 420 may apply an optimization algorithm to generate a final set of parameters of the target model 440 based on the initial set of parameters of the target model 440 (e.g., scattering parameters and/or transfer parameters). The optimization algorithm may iteratively update device coefficients of a device S-matrix representation model of the photonic circuit 430 (i.e., the target model 440) based on a comparison between the device coefficients and the target coefficients to determine a final version of the device coefficients (i.e., the final set of parameters of the target model 440). The photonic circuit 430 can be then defined in accordance with the final version of the device coefficients. At first, the optimization algorithm may be utilized to define an initial random photonic circuit (e.g., initial photonic gate). After that, the optimization algorithm may extract relevant S-matrix parameters (i.e., an initial version of the device coefficients) using a minimum number of numerical simulations (e.g., FDTD simulations). The device coefficients (i.e., the final set of parameters of the target model 440) may emulate relations between a set of photonic input signals and a set of photonic output signals for the photonic circuit 430.

The optimization algorithm applied by the modeling circuit 420 may compare the target coefficients (e.g., the target S-matrix) with the device coefficients (e.g., the extracted device S-matrix). A gradient value for the iterative algorithm of updating the device coefficients may be determined based on the comparison. The optimization algorithm may compare the target coefficients with the device coefficients using, e.g., a figure of merit (FOM) function. The optimization algorithm may determine the gradient value update based on this comparison at each iteration of the optimization algorithm. A last version of updated device coefficients determined by the iterative optimization algorithm, which is determined based on the last updated gradient value, may represent the final version of the device coefficients (i.e., the final set of parameters of the target model 440). The final version of the device coefficients may differ from the target coefficients by one or more predetermined threshold amounts. In one or more embodiments, the final version of the device coefficients may be equal to the target coefficients, and the gradient value may be equal to zero. The final version of the device coefficients may emulate operations of the target photonic circuit 430 that is being designed as a photonic super-gate.

The target model 440 may serve as a reference for designing a linear photonic super-gate. The set of parameters of the target model 440 may be passed onto the optimizer circuit 425. The optimizer circuit 425 may apply an optimization algorithm on the set of parameters of the target model 440 to instantiate photonic logic cells forming a linear photonic super-gate 445 that emulates operations of the cascaded photonic circuit 430. Alternatively, instead of applying the optimization algorithm, the optimizer circuit 425 may instantiate the linear photonic super-gate 445 by applying, e.g., an inverse-design algorithm, a machine-learning algorithm, some other design algorithm, or some combination thereof. The linear photonic super-gate 445 may perform the same operations as the cascaded photonic circuit 430. For example, the linear photonic super-gate 445 may operate as the three-input MAJ super-gate in accordance with a truth table 450. The linear photonic super-gate 445 instantiated by the emulation process 400 may be an embodiment of the linear photonic super-gate 300.

The target photonics output signals of the three-input MAJ super-gate may be represented by the truth table 450 of eight elements that defines the logic of the three-input MAJ super-gate, whereas the photonic input signals of the of the three-input MAJ super-gate are three inputs with eight possible logic combinations. To design the three-input MAJ super-gate, a final set of parameters (e.g., scattering parameters and/or transfer parameters) of the linear photonic super-gate 445 emulating operations of the three-input MAJ logic circuit may be calculated based on the target output defined with the truth table 450. The optimizer circuit 425 may generate the final set of parameters by, e.g., iteratively updating device coefficients of a device S-matrix representation model of the target photonic circuit 430 based on a comparison between the device coefficients and the target coefficients to determine a final version of the device coefficients. At the end of the process, an error between the target output (e.g., the truth table 450) and an actual output of the designed linear photonic super-gate 445 that emulates operations of the three-input MAJ logic circuit may be approximately zero.

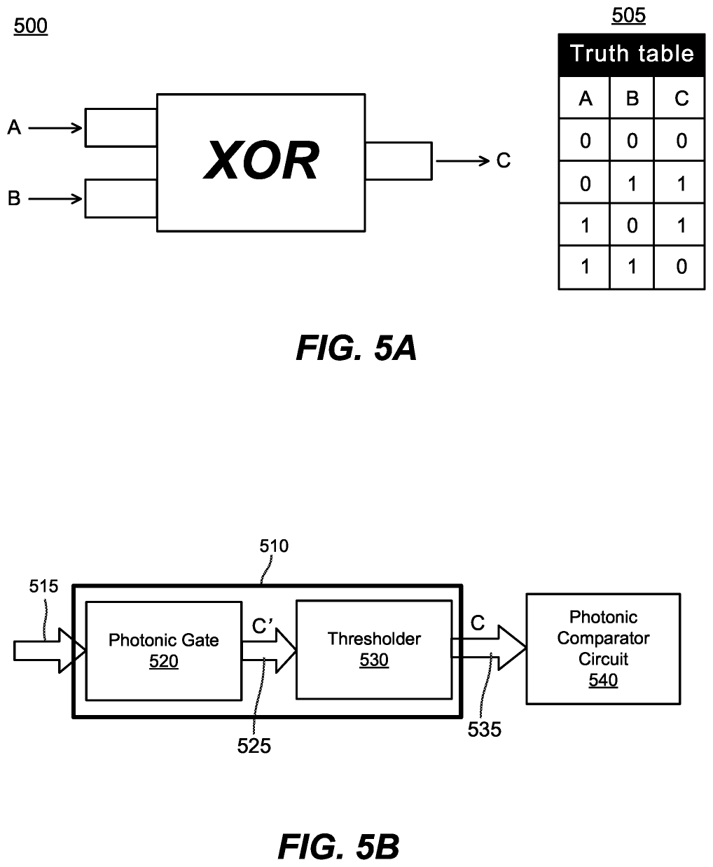

FIG. 5A illustrates an example two-input nonlinear photonic gate 500, in accordance with some embodiments. The two-input nonlinear photonic gate 500 may be a two-input exclusive ‘OR’ (XOR) photonic gate 500 that operates in accordance with the truth table 505. The nonlinear photonic gate 500 may implement a nonlinear function (e.g., XOR function) in the optical domain using linear optics elements.

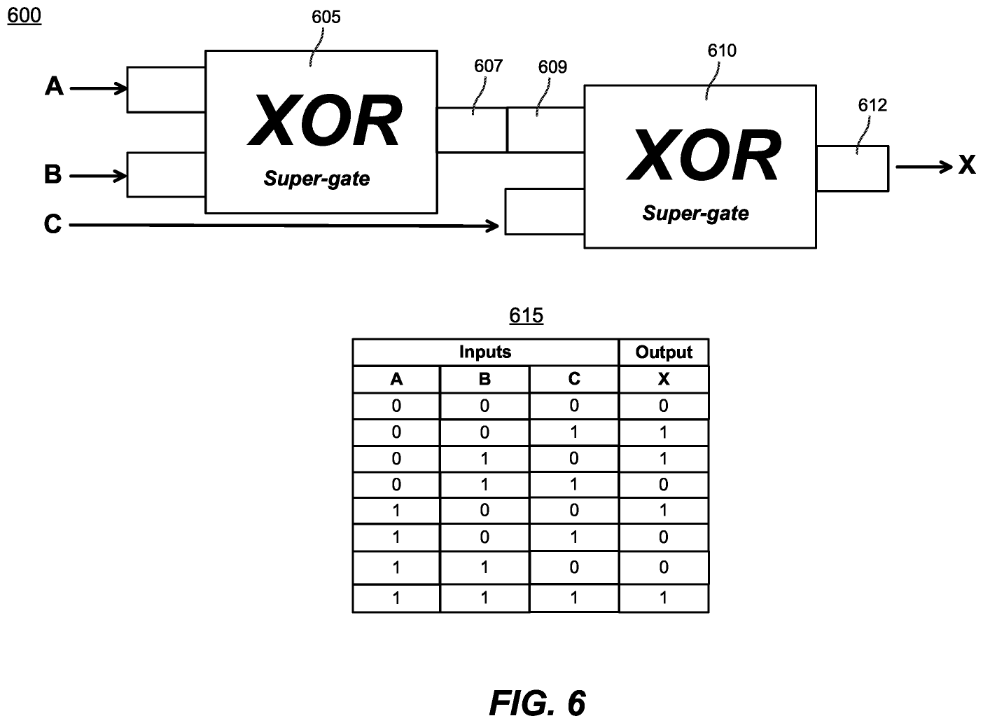

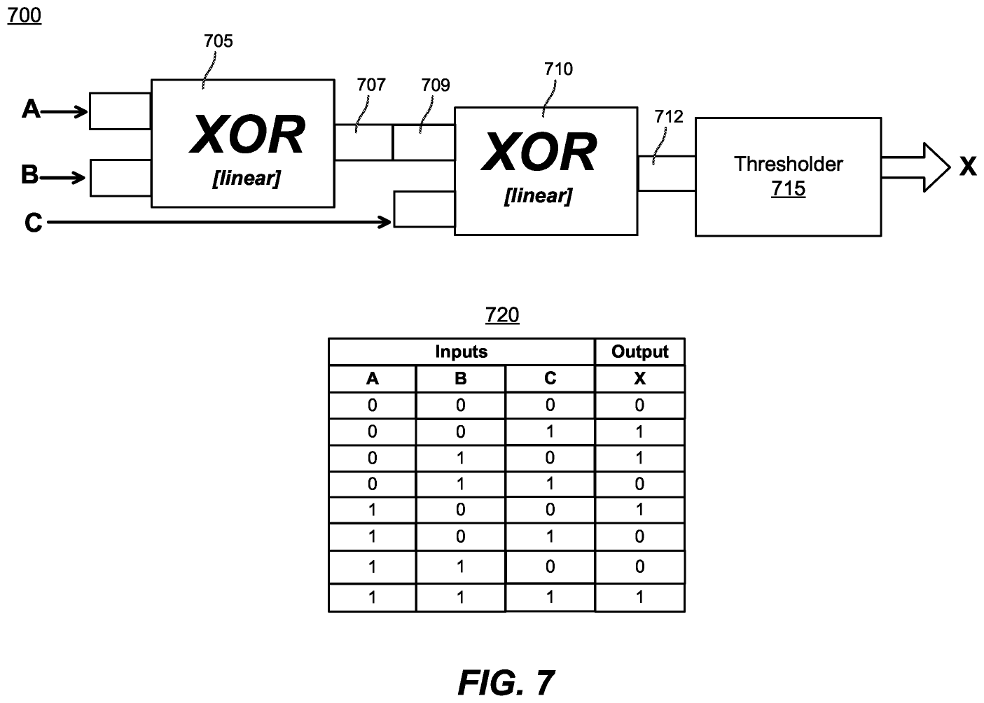

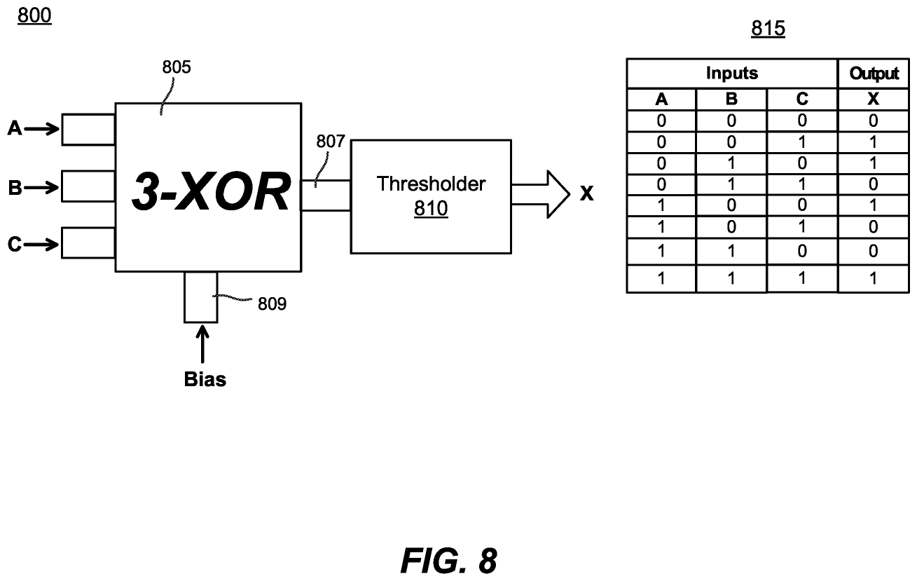

The nonlinear photonic gate 500 may receive a pair of photonic input signals A and B and generate a corresponding photonic output signal C in accordance with the truth table 505. The photonic input signals A and B may be light signals of corresponding input amplitudes (that each corresponds to logical “1” or logical “0”), corresponding input phases and/or corresponding input modes (i.e., input light spatial distribution and/or input wavelengths) injected into a set of input ports of the nonlinear photonic gate 500. The set of input ports of the nonlinear photonic gate 500 may represent, e.g., a set of waveguides, a set of waveguide polarizations, a set of waveguide modes, a set of light wavelengths, etc. The photonic output signal C may be a light signal of a corresponding output amplitude (which corresponds to logical “1” or logical “0”) detected at an output port of the nonlinear photonic gate 500. The output port of the nonlinear photonic gate 500 may represent, e.g., a waveguide, a waveguide polarization, a waveguide mode, a light wavelength, a signal radiated by the nonlinear photonic gate 500, etc. Multiple nonlinear photonic gates 500 may be cascaded to form a single photonic super-gate (e.g., as shown in FIGS. 6 and 7) that operates in accordance with a truth table larger than the truth table 505. In one or more embodiments, a phase (and/or amplitude) of the photonic output signal C is not correct, which prevents direct cascading of the nonlinear photonic gate 500 with one or more other photonic gates. In such cases, a specific correcting circuit (e.g., optical thresholder) is connected to the photonic output port of the nonlinear photonic gate 500 to correct the phase (and/or amplitude) of the photonic output signal C, e.g., as shown in relation to FIG. 5B and FIGS. 7-9.

FIG. 5B illustrates an example nonlinear photonic super-gate 510, in accordance with some embodiments. The nonlinear photonic super-gate 510 may include a photonic gate 520 and a thresholder 530 that is coupled to an output of the photonic gate 520. The photonic gate 520 may be, e.g., an XOR photonic gate implemented with cascaded linear elements. The photonic gate 520 may receive photonic inputs 515 (i.e., light waves) and generate a photonic output signal 525, C′, of a corresponding amplitude in accordance with a target truth table (e.g., the truth table 505).

Given that the photonic gate 520 operating as an XOR photonic gate is designed with linear optical elements, the photonic output signal 525 may not match the target truth table 505 in all cases. Because of that, the thresholder 530 may be connected to an output port of the photonic gate 520 to correct any errors in the output signal 525. The thresholder 530 may be, e.g., a phase/amplitude/mode/wavelength corrector circuit that corrects an accumulative error (e.g., phase error, amplitude error, mode error, wavelength error, bit error, some other type of error, or some combination thereof) in the photonic output signal 525 resulting from the photonic gate 520 composed of linear elements. The thresholder 530 may be implemented as, e.g., an electro-optical thresholder, optical thresholder, saturable optical absorber, semiconductor optical amplifier, or some other corrector circuit that corrects one or more accumulative errors generated by the photonic gate 520. The thresholder 530 may generate a photonic output signal 535, C, which is an error-free version of the photonic output signal 525, C′. In this manner, an output truth table of the nonlinear photonic super-gate 510 corresponds to the target truth table 505, which can be verified by a photonic comparator circuit 540.

It should be noted that all photonic connections within the nonlinear photonic super-gate 510 (including input and output ports) may be implemented as silicon waveguides. The photonic gate 520 and the photonic comparator circuit 540 may be implemented as silicon photonic circuits. The thresholder 530 (i.e., nonlinear photonic circuit) may be implemented in the III-V platform using a saturated absorber, SOA, saturated gain, or some combination thereof. In such cases, the thresholder 530 may be heterogeneously integrated within the nonlinear photonic super-gate 510. Alternatively, the thresholder 530 may be implemented with electro-optical devices such as photodetectors, modulators, CMOS TIAs, and any other element that improves the design. In such cases, the thresholder 530 may be CMOS monolithically integrated within the nonlinear photonic super-gate 510. Alternatively or additionally, the thresholder 530 may also be fiber attached, micro-transfer printed, flip-chipped, optically and/or electronically wire-bonded within the nonlinear photonic super-gate 510.

FIG. 6 illustrates an example nonlinear photonic circuit 600 with cascaded photonic super-gates, in accordance with some embodiments. The nonlinear photonic circuit 600 may include a first nonlinear photonic super-gate 605 (e.g., first XOR photonic super-gate) cascaded to a second nonlinear photonic super-gate 610 (e.g., second XOR photonic super-gate). Each of the first nonlinear photonic super-gate gate 605 and the second nonlinear photonic super-gate 610 may be an embodiment of the nonlinear photonic super-gate 510.

The nonlinear photonic circuit 600 may receive three independent photonic input signals, A, B, and C, and generate a photonic output signal X of a corresponding amplitude in accordance with a truth table 615. The photonic input signals A, B and C may be light signals of corresponding input amplitudes (that each corresponds to logical “1” or logical “0”), corresponding input phases and/or corresponding input modes (i.e., input light spatial distribution and/or input wavelengths). As shown in FIG. 6, an output port 607 of the first nonlinear photonic super-gate 605 may be directly connected to an input port 609 of the second nonlinear photonic super-gate 610. A photonic output signal of the first nonlinear photonic super-gate 605 generated at the output port 607 may be directly input into the input port 609 of the second nonlinear photonic super-gate 610. In this manner, two cascaded nonlinear photonic super-gates 605, 610 may form the nonlinear photonic circuit 600 that represents a three-input XOR super-gate that operates in accordance with the truth table 615 larger than a truth table of individual nonlinear photonic super-gates. The photonic output signal X detected at an output port 612 of the second nonlinear photonic super-gate 610 may be a light signal of a corresponding output amplitude (which corresponds to logical “1” or logical “0”). The output port 612 may represent an output port of the nonlinear photonic circuit 600.

It should be noted that all photonic connections within the nonlinear photonic circuit 600 (including input and output ports) may be implemented as silicon waveguides. Nonlinear components (e.g., thresholders) within the first and second nonlinear photonic super-gates 605, 610 may be implemented in the III-V platform using a saturated absorber, SOA, saturated gain, or some combination thereof. In such cases, the nonlinear components may be heterogeneously integrated with silicon photonic circuits of the first and second nonlinear photonic super-gates 605, 610. Alternatively, the nonlinear components may be implemented with electro-optical devices such as photodetectors, modulators, CMOS TIAs, and any other element that improves the design. In such cases, the nonlinear components may be CMOS monolithically integrated with silicon photonic circuits of the first and second nonlinear photonic super-gates 605, 610. Alternatively or additionally, the nonlinear components may also be fiber attached, micro-transfer printed, flip-chipped, optically and/or electronically wire-bonded to other components of the nonlinear photonic circuit 600.

FIG. 7 illustrates an example nonlinear cascaded photonic circuit 700 implemented with linear optics, in accordance with some embodiments. The nonlinear cascaded photonic circuit 700 may include a first linear photonic gate 705 (e.g., first XOR photonic gate) cascaded to a second linear photonic gate 710 (e.g., second XOR photonic gate). Each of the first linear photonic gate 705 and the second linear photonic gate 710 may be implemented using, e.g., linear optical gates. Each of the first linear photonic gate 705 and the second linear photonic gate 710 may be an embodiment of the photonic gate 520.

The nonlinear cascaded photonic circuit 700 may further include a thresholder 715 connected to an output port 712 of the second linear photonic gate 710. The thresholder 715 may be, e.g., a phase/amplitude/mode/wavelength corrector circuit that corrects an accumulative error (e.g., phase error, amplitude error, mode error, wavelength error, bit error, some other type of error, or some combination thereof) in a photonic output signal generated at the output port 712 resulting from cascading photonic gates 705 and 710 implemented with only linear optics. The thresholder 715 may be implemented as, e.g., an electro-optical thresholder, optical thresholder, saturable optical absorber, semiconductor optical amplifier, or some other corrector circuit that corrects one or more accumulative errors generated by the cascading connection of photonic gates 705 and 710 implemented with linear optics.

The nonlinear cascaded photonic circuit 700 may receive three independent photonic input signals, A, B and C, and generate a photonic output signal X of a corresponding amplitude in accordance with a truth table 720. The photonic input signals A, B and C may be light signals of corresponding input amplitudes (that each corresponds to logical “1” or logical “0”), corresponding input phases and/or corresponding input modes (i.e., input light spatial distribution and/or input wavelengths). As shown in FIG. 7, an output port 707 of the first linear photonic gate 705 may be directly connected to an input port 709 of the second linear photonic gate 710. A photonic output signal of the first linear photonic gate 705 generated at the photonic output port 707 may be directly input into the input port 709 of the second linear photonic gate 710. In this manner, two cascaded linear photonic gates 705, 710, together with the thresholder 715, may form the nonlinear cascaded photonic circuit 700 that represents a three-input XOR photonic circuit that operates in accordance with the truth table 720 larger than a truth table of individual nonlinear photonic gates (e.g., larger than the truth table 505).

It should be noted that all photonic connections within the nonlinear cascaded photonic circuit 700 (including input and output ports) may be implemented as silicon waveguides. The first and second linear photonic gates 705, 710 may be implemented as silicon photonic circuits. The thresholder 715 (i.e., nonlinear photonic circuit) may be implemented with a SOA in the III-V platform. In such cases, the thresholder 715 may be heterogeneously integrated within the nonlinear cascaded photonic circuit 700. Alternatively, the thresholder 715 may be implemented with electro-optical devices such as photodetectors, modulators, CMOS TIAs, and any other element that improves the design. In such cases, the thresholder 715 may be CMOS monolithically integrated within the nonlinear cascaded photonic circuit 700. Alternatively or additionally, the thresholder 715 may also be fiber attached, micro-transfer printed, flip-chipped, optically and/or electronically wire-bonded within the nonlinear cascaded photonic circuit 700.

FIG. 8 illustrates an example nonlinear photonic circuit 800 with a photonic super-gate 805, in accordance with some embodiments. The nonlinear photonic circuit 800 with the photonic super-gate 805 may perform the same operations as the cascaded photonic circuit 700, i.e., the photonic super-gate 805 may operate as a three-input XOR super-gate. Thus, the photonic super-gate 805 may represent a single photonic “super” gate that implements operations of multiple cascaded photonic gates (e.g., cascaded linear photonic gates 705 and 710 in FIG. 7) and generate a photonic output signal in accordance with a truth table 815. Note that the truth table 815 is identical to the truth table 720.

An output port 807 of the photonic super-gate 805 may be directly connected to an input port of a thresholder 810 (e.g., phase/amplitude/mode/wavelength corrector). The thresholder 810 may be configured to correct an accumulative error (e.g., phase error, amplitude error, mode error, wavelength error, bit error, some other type of error, or some combination thereof) resulting from the emulation of cascaded linear photonic gates when operating the photonic super-gate 805. The thresholder 810 may correct for any phase error, amplitude error, mode error, wavelength error, bit error, some other type of error, or some combination thereof resulting from designing the photonic super-gate 805 with linear optics. The thresholder 810 may be implemented as, e.g., an electro-optical thresholder, optical thresholder, saturable optical absorber, semiconductor optical amplifier, or some other corrector circuit that corrects one or more accumulative errors generated by the photonic super-gate 805 implemented with linear optics.

As shown in FIG. 8, the photonic super-gate 805 may further include a bias port 809 for inputting a bias signal. The bias port 809 of the photonic super-gate 805 may represent, e.g., a waveguide, a waveguide polarization, a waveguide mode, a light wavelength, etc. The bias signal input at the bias port 809 may be a light signal of a defined amplitude level that is constant over time. The bias signal may be generated by, e.g., a photonic local source coupled to the bias port 809 (not shown in FIG. 8). Similarly, the output port 807 of the photonic super-gate 805 may represent, e.g., a waveguide, a waveguide polarization, a waveguide mode, a light wavelength, a signal radiated by the photonic super-gate 805, etc.

The photonic signals A, B and C input into the photonic super-gate 805 may be light signals of corresponding input amplitudes (that each corresponds to logical “1” or logical “0”), corresponding input phases and/or corresponding input modes (i.e., input light spatial distribution and/or input wavelengths) injected into a set of input ports of the photonic super-gate 805. The set of input ports of the photonic super-gate 805 may represent, e.g., a set of waveguides, a set of waveguide polarizations, a set of waveguide modes, a set of light wavelengths, etc. A photonic output signal X detected an output port of the thresholder 810 may be a light signal of a corresponding output amplitude (which corresponds to logical “1” or logical “0”). The output port of the thresholder 810 may represent, e.g., a waveguide, a waveguide polarization, a waveguide mode, a light wavelength, a signal radiated by the thresholder 810, etc.

It should be noted that all photonic connections within the nonlinear photonic circuit 800 (including input and output ports) may be implemented as silicon waveguides. The photonic super-gate 805 may be implemented using silicon photonic gates. The thresholder 810 (i.e., nonlinear photonic circuit) may be implemented in the III-V platform using a saturated absorber, SOA, saturated gain, or some combination thereof. In such cases, the thresholder 810 may be heterogeneously integrated with the photonic super-gate 805. Alternatively, the thresholder 810 may be implemented with electro-optical devices such as photodetectors, modulators, CMOS TIAs, and any other element that improves the design. In such cases, the thresholder 810 may be CMOS monolithically integrated with the photonic super-gate 805. Alternatively or additionally, the thresholder 810 may also be fiber attached, micro-transfer printed, flip-chipped, optically and/or electronically wire-bonded within the nonlinear photonic circuit 800.

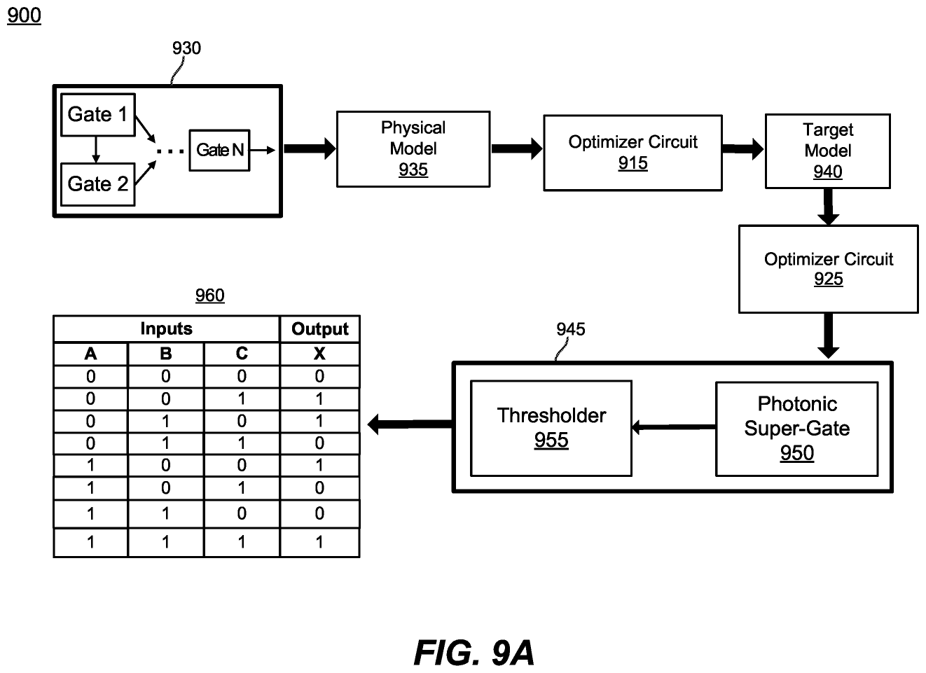

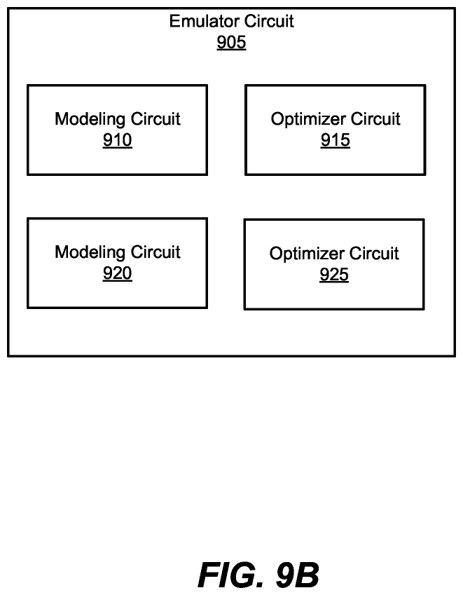

Details about the efficient designing of photonic super-gates (e.g., the photonic super-gates 600, 700, 800) are provided in relation to FIGS. 9A-9B.

FIG. 9A illustrates an example process 900 of designing a nonlinear photonic super-gate, in accordance with some embodiments. The process 900 may be executed by components of an emulator circuit 905 shown in FIG. 9B. The emulator circuit 905 may include a modeling circuit 910, an optimizer circuit 915 having a set of one or more inputs directly connected to a set of one or more outputs of the modeling circuit 910, a modeling circuit 920 having a set of one or more inputs directly connected to a set of one or more outputs of the optimizer circuit 915, and an optimizer circuit 925 having a set of one or more inputs directly connected to a set of one or more outputs of the modeling circuit 920. The emulator circuit 905 may include additional components not shown in FIG. 9B. Alternatively, some components of the emulator circuit 905 may be combined into a single module for performing multiple operations. In some embodiments, the emulator circuit 905 is deployed in a computing system that can further includes, as previously described, one or more processors (and corresponding memory) and a non-transitory computer-readable storage medium (e.g., optical, electrical, or electro-optical memory) for storing computer-executable instructions and data executable by the one or more processors to perform the process 900 as described.

In one or more embodiments, a design is a single nonlinear photonic super-gate that is area-efficient and power-efficient while performing the same operations as a target photonic circuit 930 with cascaded photonic gates. Note that the target photonic circuit 930 may include a plurality of cascaded photonic gates (e.g., N cascaded photonic gates, where N≥2). Initially, the modeling circuit 910 may generate, using a truth table of the photonic circuit 930, a set of parameters of a physical model 935 for the photonic circuit 930. The set of parameters of the physical model 935 may be passed onto the optimizer circuit 915. The optimizer circuit 915 may apply a numerical optimization algorithm on the set of parameters of the physical model 910 to estimate an initial set of parameters (e.g., scattering parameters and/or transfer parameters) of a target model 940 for the photonic circuit 935. To estimate the initial set of parameters of the target model 940, the optimizer circuit 915 may apply the inverse design that utilizes FDTD simulations, FDFD simulations, machine learning algorithm, artificial intelligence-based algorithm, any other suitable numerical optimization algorithm, or some combination thereof.

Note that for a given photonic circuit with photonic inputs and photonic outputs (e.g., for the target photonic circuit 930), a scattering matrix with scattering parameters (or complex coefficients) defines the relations between corresponding photonic inputs and corresponding photonic outputs. A transfer function with transfer parameters defines the absolute value of the relations between photonic inputs and photonic outputs of the photonic circuit. Note also that photonic input signals and photonic output signals of the target photonic circuit 930 are known. However, to design a photonic super-gate that performs the same operations as the target photonic circuit 930 with cascaded photonic gates, it may be required to calculate target coefficients (e.g., scattering parameters and/or transfer parameters) based on the target output. The optimizer circuit 915 may generate the target coefficients by, e.g., iteratively updating device coefficients of a device S-matrix representation model of the target photonic circuit 930 based on a comparison between the device coefficients and the target coefficients to determine a final version of the device coefficients. The initial set of parameters (e.g., scattering parameters and/or transfer parameters) of the target model 940 may be passed onto the modeling circuit 920.

In some embodiments, the optimizer circuit 915 instantiates a library of cells for a nonlinear photonic super-gate based on a set of photonic inputs and a set of one or more photonic outputs defined by the truth table of the photonic circuit 930 that are input into the optimizer circuit 915. Each cell may be designed using an optimization algorithm (e.g., FDTD-based optimization algorithm, FDFD-based optimization algorithm, machine learning algorithm, artificial intelligence-based algorithm, etc.). After that, the target output (e.g., truth table) may be compared with the actual output of the cell to ensure correct functionality of the cell. Once all cells are designed, the cells may be cascaded by plugging the cells to each other via waveguides. Additionally, thresholders may be included in between the output of one cell and the input of the next cascaded cell to correct for any phase and/or amplitude error.

The modeling circuit 920 may apply an optimization algorithm to generate a final set of parameters of the target model 940 based on the initial set of parameters of the target model 940 (e.g., scattering parameters and/or transfer parameters). The optimization algorithm may iteratively update device coefficients of a device S-matrix representation model of the photonic circuit 930 (i.e., the target model 940) based a comparison between the device coefficients and the target coefficients to determine a final version of the device coefficients (i.e., the final set of parameters of the target model 940). The photonic circuit 930 can be then defined in accordance with the final version of the device coefficients. At first, the optimization algorithm may be utilized to define an initial random photonic circuit (e.g., initial photonic gate). After that, the optimization algorithm may extract relevant S-matrix parameters (i.e., an initial version of the device coefficients) using a minimum number of numerical simulations (e.g., FDTD simulations). The device coefficients (i.e., the final set of parameters of the target model 940) may emulate relations between a set of photonic input signals and a set of photonic output signals for the photonic circuit 930.

The optimization algorithm applied by the modeling circuit 920 may compare the target coefficients (e.g., the target S-matrix) with the device coefficients (e.g., the extracted device S-matrix). A gradient value for the iterative algorithm of updating the device coefficients may be determined based on the comparison. The optimization algorithm may compare the target coefficients with the device coefficients using, e.g., an FOM function. The optimization algorithm may determine the gradient value update based on this comparison at each iteration of the optimization algorithm. A last version of updated device coefficients determined by the iterative optimization algorithm, which is determined based on the last updated gradient value, may represent the final version of the device coefficients (i.e., the final set of parameters of the target model 940). The final version of the device coefficients may differ from the target coefficients by one or more predetermined threshold amounts. In one or more embodiments, the final version of the device coefficients may be equal to the target coefficients, and the gradient value may be equal to zero. The final version of the device coefficients may emulate operations of the target photonic circuit 930 that is being designed as a photonic super-gate.

The target model 940 may serve as a reference for designing a nonlinear photonic super-gate. The set of parameters of the target model 940 may be passed onto the optimizer circuit 925. The optimizer circuit 925 may apply an optimization algorithm on the set of parameters of the target model 940 to design photonic logic cells that form a nonlinear photonic super-circuit 945 that emulates operations of the cascaded photonic circuit 930. Alternatively, instead of applying the optimization algorithm, the optimizer circuit 925 may instantiate the nonlinear photonic super-circuit 945 by applying, e.g., an inverse-design algorithm, a machine-learning algorithm, some other design algorithm, or some combination thereof.

The emulator circuit 905 may apply the process 900 to instantiate the nonlinear photonic super-circuit 945 that includes a photonic super-gate 950 and a thresholder 955 coupled to an output port of the photonic super-gate 950. The photonic super-gate 950 may perform the same operations as the cascaded photonic circuit 930. For example, the photonic super-gate 950 may operate as a three-input XOR super-gate in accordance with a truth table 960. Thus, the photonic super-gate 950 may be an embodiment of the photonic super-gate 805. In one or more embodiments, the photonic super-gate 950 is composed of linear optical components.

The thresholder 955 may be directly connected to the output port of the photonic super-gate 950 to correct an accumulative error (e.g., phase error, amplitude error, mode error, wavelength error, bit error, some other type of error, or some combination thereof) resulting from the emulation of cascaded linear photonic gates when operating the photonic super-gate 950. The thresholder 955 may correct for any phase error, amplitude error, mode error, wavelength error, bit error, some other type of error, or some combination thereof resulting from operating the photonic super-gate 950 with linear optical components. The thresholder 955 may be, e.g., an electro-optical thresholder, a passive (e.g., Si or SiN based) nonlinear thresholder, a passive or active (e.g., III-V compound semiconductor based, graphene based, etc.) nonlinear thresholder, some other type of thresholder, or some combination thereof.

The thresholder 955 implemented as an electro-optical thresholder may be suitable for correcting one or more accumulative errors (e.g., phase errors and/or amplitude errors) made by the photonic super-gate 950 that includes an O-E-O (optical-electrical-optical) link, i.e., a cascaded connection of a photonic circuit (e.g., photodetector), an electronic circuit or an electronic element (e.g., resistor, comparator and/or driver), and another photonic circuit (e.g., photonic modulator). The thresholder 955 implemented as a passive nonlinear thresholder may be suitable for correcting one or more accumulative errors (e.g., phase errors and/or amplitude errors) made by the photonic super-gate 950 that performs a nonlinear function. The thresholder 955 implemented as a nonlinear thresholder (passive or active) may be suitable for correcting one or more accumulative errors (e.g., phase errors and/or amplitude errors) made by the photonic super-gate 950 that operates as, e.g., a photonic semiconductor optical amplifier or a photonic device based on a gain medium. In one or more embodiments, the thresholder 955 is replaced with a bit-corrector circuit. The bit-corrector circuit may correct accumulative bit errors made by a photonic super-gate by utilizing combination of a photonic bit-corrector circuit and an electronic (e.g., comparator-based) bit-corrector circuit. The nonlinear photonic super-circuit 945 that includes the photonic super-gate 950 and the thresholder 955 (or the bit-corrector circuit) may operate as, e.g., three-input XOR super-gate in accordance with the truth table 960. The nonlinear photonic super-circuit 945 may be an embodiment of the nonlinear photonic circuit 800.

The target photonics output signals of the three-input XOR super-gate may be represented by the truth table 960 of eight elements that defines the logic of the three-input XOR super-gate, whereas the photonic input signals of the of the three-input XOR super-gate are three inputs with eight possible logic combinations. To design the three-input XOR super-gate, a final set of parameters (e.g., scattering parameters and/or transfer parameters) of the nonlinear photonic super-circuit 945 emulating operations of the three-input XOR logic circuit may be calculated based on the target output defined with the truth table 960. The optimizer circuit 925 may generate the final set of parameters by, e.g., iteratively updating device coefficients of a device S-matrix representation model of the target photonic circuit 930 based on a comparison between the device coefficients and the target coefficients to determine a final version of the device coefficients. At the end of the process, an error between the target output (e.g., the truth table 960) and an actual output of the designed nonlinear photonic super-circuit 945 that emulates operations of the three-input XOR logic circuit may be approximately zero.

It should be noted that all photonic connections within the nonlinear photonic super-circuit 945 (including input and output ports) may be implemented as silicon waveguides. The photonic super-gate 950 may be implemented using silicon photonic gates. The thresholder 955 (i.e., nonlinear photonic circuit) may be implemented in the III-V platform using a saturated absorber, SOA, saturated gain, or some combination thereof. In such cases, the thresholder 955 may be heterogeneously integrated with the photonic super-gate 950. Alternatively, the thresholder 955 may be implemented with electro-optical devices such as photodetectors, modulators, CMOS TIAs, and any other element that improves the design. In such cases, the thresholder 955 may be CMOS monolithically integrated with the photonic super-gate 950. Alternatively or additionally, the thresholder 955 may also be fiber attached, micro-transfer printed, flip-chipped, optically and/or electronically wire-bonded within the nonlinear photonic super-circuit 945.

### Example Process Flow

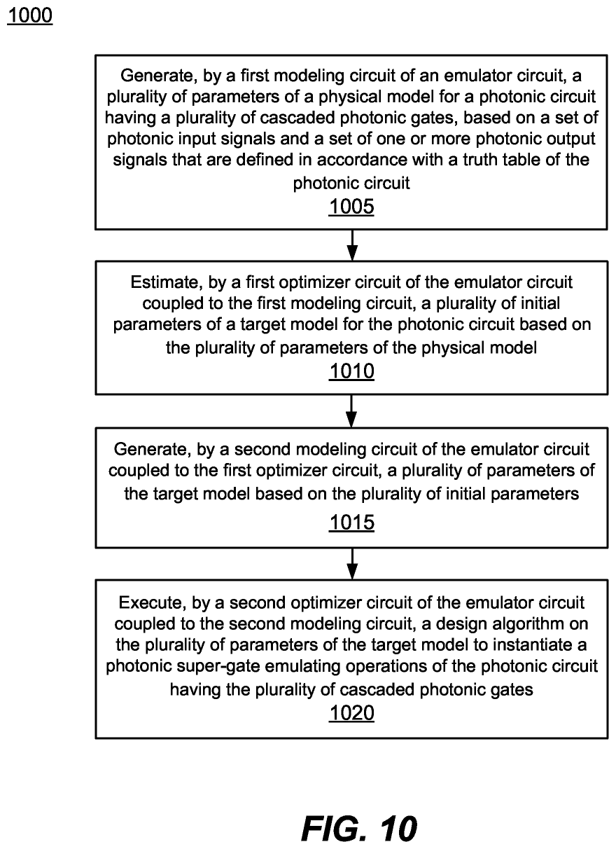

FIG. 10 is a flowchart illustrating an example method 1000 for instantiating a nonlinear photonic super-gate at an emulator circuit, in accordance with some embodiments. The operations of method 1000 may be performed by components of the emulator circuit 905. The nonlinear photonic super-gate may be part of a photonic processor that is implemented as a silicon photonics platform. The photonic processor may be deployed in a computing system that can further include a non-transitory computer-readable storage medium (e.g., optical, electrical, or electro-optical memory) for storing computer-executable instructions and data. The computing system may be an optical computing system, an electronic computing system, an electro-optical computing system, some other type of computing system, or some combination thereof.

The emulator circuit generates 1005 (e.g., by the modeling circuit 910) a plurality of parameters of a physical model (e.g., the physical model 935) for a photonic circuit having a plurality of cascaded photonic gates (e.g., the photonic circuit 930), based on a set of photonic input signals and a set of one or more photonic output signals that are defined in accordance with a truth table of the photonic circuit. The emulator circuit estimates 1010 (e.g., by the optimizer circuit 915), based on the plurality of parameters of the physical model, a plurality of initial parameters of a target model for the photonic circuit (e.g., the target model 940).

The emulator circuit may estimate (e.g., by the optimizer circuit 915), based on the plurality of parameters of the physical model, the plurality of initial parameters of the target model including at least one of a plurality of scattering parameters and a plurality of transfer parameters. The emulator circuit may further generate (e.g., by the optimizer circuit 915), based on the set of photonic input signals and the set of one or more photonic output signals, a library of cells for the photonic super-gate.

The emulator circuit generates 1015 (e.g., by the modeling circuit 920), based on the plurality of initial parameters, a plurality of parameters of the target model. The emulator circuit executes 1020 (e.g., by the optimizer circuit 925) a design algorithm using the plurality of parameters of the target model to instantiate a photonic super-gate (e.g., the photonic super-gate 950) emulating operations of the photonic circuit having the plurality of cascaded photonic gates.

The photonic super-gate may be composed of one or more linear photonic elements. The emulator circuit may execute (e.g., by the optimizer circuit 925) the design algorithm using the plurality of parameters of the target model to instantiate a nonlinear photonic super-circuit (e.g., the nonlinear photonic super-circuit 945) including the photonic super-gate (e.g., the photonic super-gate 950) and a nonlinear thresholder circuit (e.g., the thresholder 955) coupled to an output port of the photonic super-gate. The nonlinear photonic super-circuit may emulate nonlinear operations of the photonic circuit having the plurality of cascaded photonic gates.

The nonlinear thresholder circuit may correct one or more accumulative errors in a first photonic output signal generated by the photonic super-gate and output at the output port of the photonic super-gate. The nonlinear thresholder circuit may further generate a second photonic output signal at an output port of the nonlinear photonic super-circuit, wherein the second photonic output signal is an error-free version of the first photonic output signal. In one or more embodiments, the nonlinear thresholder circuit includes one or more electro-optical thresholders. In one or more other embodiments, the nonlinear thresholder circuit includes one or more semiconductor optical amplifier-based amplitude thresholders. In one or more other embodiments, the nonlinear thresholder circuit includes one or more saturable absorbers.

In one or more embodiments, the emulator circuit executes (e.g., by the optimizer circuit 925) the design algorithm by executing an optimization algorithm using the plurality of parameters of the target model to instantiate a plurality of photonic logic cells that form the photonic super-gate. In one or more other embodiments, the emulator circuit executes (e.g., by the optimizer circuit 925) the design algorithm by executing an inverse-design algorithm using the plurality of parameters of the target model to instantiate a plurality of photonic logic cells that form the photonic super-gate. In one or more other embodiments, the emulator circuit executes (e.g., by the optimizer circuit 925) the design algorithm using the plurality of parameters of the target model to instantiate a plurality of photonic logic cells forming a nonlinear photonic super-circuit that includes the photonic super-gate and a nonlinear thresholder circuit coupled to an output port of the photonic super-gate, the nonlinear photonic super-circuit emulating nonlinear operations of the photonic circuit having the plurality of cascaded photonic gates.

### Additional Considerations

The disclosed configurations beneficially provide for efficient design of photonic logic gates while substantially reducing a number of required numerical design simulations. Moreover, the circuits noted may be designed and simulated with electronic, electronic-photonic and/or photonic design automation tools (referred to herein as “design automation”) and represented as circuit layouts stored in an electronic library, electronic-photonic library and/or photonic library. The circuit designs may be retrieved and incorporated into designs of chips including the retrieved design.

The design automation may include a set of processes used during the design, verification, and fabrication of an article of manufacture such as an integrated circuit (e.g., photonic integrated circuit) to transform and verify design data and instructions that represent the integrated circuit. Each of these processes can be structured and enabled as multiple modules or operations. These processes may start with the creation of a product idea with information supplied by a designer, information which is transformed to create an article of manufacture that uses a set of design automation processes. When the design is finalized, the design can be taped-out, which is when artwork (e.g., geometric patterns) for the integrated circuit is sent to a fabrication facility to manufacture the mask set, which is then used to manufacture the integrated circuit. After tape-out, a die (e.g., photonic die) is fabricated and packaging and assembly processes are performed to produce the finished integrated circuit.

During system design as part of design automation, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification as part of design automation, modules or components in the integrated circuit are specified in one or more description languages and the specification is checked for functional accuracy. For example, the components of the integrated circuit may be verified to generate outputs that match the requirements of the specification of the integrated circuit or system being designed. Functional verification may use simulators and other programs such as testbench generators, static hardware description language (‘HDL’) checkers, and formal verifiers. In some embodiments, special systems of components referred to as ‘emulators’ or ‘prototyping systems’ are used to speed up the functional verification. During design planning as part of design automation, an overall floor plan for the integrated circuit is constructed and analyzed for timing and top-level routing.

During layout or physical implementation as part of design automation, physical placement (positioning of circuit components) and routing (connection of the circuit components) occurs, and the selection of cells from a library to enable specific logic functions can be performed. As used herein, the term ‘cell’ may specify a set of components and interconnections that provides a Boolean logic function (e.g., AND, OR, NOT, XOR, etc.) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by design automation products.

The foregoing description of the embodiments of the disclosure has been presented for the purpose of illustration; it is not intended to be exhaustive or to limit the disclosure to the precise forms disclosed. Persons skilled in the relevant art can appreciate that many modifications and variations are possible in light of the above disclosure.

Some portions of this description describe the embodiments of the disclosure in terms of algorithms and symbolic representations of operations on information. These algorithmic descriptions and representations are commonly used by those skilled in the data processing arts to effectively convey the substance of their work to others skilled in the art. While described functionally, computationally, or logically, these operations are understood to be implemented by computer programs or equivalent electrical circuits, microcode, or the like. Furthermore, at times, it has also proven convenient to refer to these arrangements of operations as modules without loss of generality. The described operations and associated modules can be embodied in software, firmware, hardware, or some combination thereof.

Any steps, operations, or processes described herein can be performed or implemented with one or more hardware or software modules, alone or in combination with other devices. In one embodiment, a software module is implemented with a computer program product comprising a computer-readable medium containing computer program code, which a computer processor can execute for performing any or all of the steps, operations, or processes described herein.

Embodiments of the disclosure can also relate to an apparatus for performing the operations herein. This apparatus can be specially constructed for the required purposes, and/or it can include a general-purpose computing device selectively activated or reconfigured by a computer program stored in the computer. Such a computer program can be stored in a non-transitory, tangible computer-readable storage medium or any media suitable for storing electrical instructions coupled to a computer system bus. Furthermore, any computing systems referred to in the specification can include a single processor or architectures employing multiple processor designs for increased computing capability.

Some embodiments of the present disclosure can further relate to a system comprising a processor, at least one computer processor, and a non-transitory computer-readable storage medium. The storage medium can store computer-executable instructions, which, when executed by the compiler operating on at least one computer processor, cause at least one computer processor to be operable for performing the operations and techniques described herein.

Finally, the language used in the specification has been principally selected for readability and instructional purposes, and it has not been selected to delineate or circumscribe the inventive subject matter. It is therefore intended that the scope of the disclosure be limited not by this detailed description but rather by any claims that issue on an application based hereon. Accordingly, the disclosure of the embodiments is intended to be illustrative, but not to limit the scope of the disclosure, which is set forth in the following claims.

What is claimed is:

1. An emulator circuit, comprising:
a first modeling circuit configured to generate a plurality of parameters of a physical model for a photonic circuit having a plurality of cascaded photonic gates, based on a set of photonic input signals and a set of one or more photonic output signals that are defined in accordance with a truth table of the photonic circuit;
a first optimizer circuit coupled to the first modeling circuit and configured to estimate, based on the plurality of parameters of the physical model, a plurality of initial parameters of a target model for the photonic circuit;
a second modeling circuit coupled to the first optimizer circuit and configured to generate, based on the plurality of initial parameters, a plurality of parameters of the target model; and
a second optimizer circuit coupled to the second modeling circuit and configured to execute a design algorithm using the plurality of parameters of the target model to instantiate a photonic super-gate emulating operations of the photonic circuit having the plurality of cascaded photonic gates.

2. The emulator circuit of claim 1, wherein the second optimizer circuit is further configured to:
execute the design algorithm using the plurality of parameters of the target model to instantiate a nonlinear photonic super-circuit including the photonic super-gate and a nonlinear thresholder circuit coupled to an output port of the photonic super-gate, the nonlinear photonic super-circuit emulating nonlinear operations of the photonic circuit having the plurality of cascaded photonic gates.

3. The emulator circuit of claim 2, wherein the nonlinear thresholder circuit is configured to:
correct one or more accumulative errors in a first photonic output signal generated by the photonic super-gate and output at the output port of the photonic super-gate; and
generate a second photonic output signal at an output port of the nonlinear photonic super-circuit, wherein the second photonic output signal is an error-free version of the first photonic output signal.

4. The emulator circuit of claim 2, wherein the nonlinear thresholder circuit comprises one or more electro-optical thresholders.

5. The emulator circuit of claim 2, wherein the nonlinear thresholder circuit comprises one or more semiconductor optical amplifier-based amplitude thresholders.

6. The emulator circuit of claim 2, wherein the nonlinear thresholder circuit comprises one or more saturable absorbers.

7. The emulator circuit of claim 1, wherein the photonic super-gate comprises one or more linear photonic elements.

8. The emulator circuit of claim 1, wherein the first optimizer circuit is further configured to:
generate, based on the set of photonic input signals and the set of one or more photonic output signals, a library of cells for the photonic super-gate.

9. The emulator circuit of claim 1, wherein the first optimizer circuit is further configured to:
estimate, based on the plurality of parameters of the physical model, the plurality of initial parameters of the target model including at least one of a plurality of scattering parameters and a plurality of transfer parameters.

10. The emulator circuit of claim 1, wherein the second optimizer circuit is further configured to:
execute the design algorithm by executing an optimization algorithm using the plurality of parameters of the target model to instantiate a plurality of photonic logic cells that form the photonic super-gate.

11. The emulator circuit of claim 1, wherein the second optimizer circuit is further configured to:
execute the design algorithm by executing an inverse-design algorithm using the plurality of parameters of the target model to instantiate a plurality of photonic logic cells that form the photonic super-gate.

12. The emulator circuit of claim 1, wherein the second optimizer circuit is further configured to:
execute the design algorithm using the plurality of parameters of the target model to instantiate a plurality of photonic logic cells forming a nonlinear photonic super-circuit that includes the photonic super-gate and a nonlinear thresholder circuit coupled to an output port of the photonic super-gate, the nonlinear photonic super-circuit emulating nonlinear operations of the photonic circuit having the plurality of cascaded photonic gates.

13. A non-transitory computer-readable storage medium comprising stored instructions that, when executed by at least one processor of an emulator circuit, cause the at least one processor to:
instruct a first modeling circuit of the emulator circuit to generate a plurality of parameters of a physical model for a photonic circuit having a plurality of cascaded photonic gates, based on a set of photonic input signals and a set of one or more photonic output signals that are defined in accordance with a truth table of the photonic circuit;
instruct a first optimizer circuit of the emulator circuit coupled to the first modeling circuit to estimate, based on the plurality of parameters of the physical model, a plurality of initial parameters of a target model for the photonic circuit;
instruct a second modeling circuit of the emulator circuit coupled to the first optimizer circuit to generate, based on the plurality of initial parameters, a plurality of parameters of the target model; and
instruct a second optimizer circuit of the emulator circuit coupled to the second modeling circuit to execute a design algorithm using the plurality of parameters of the target model to instantiate a photonic super-gate emulating operations of the photonic circuit having the plurality of cascaded photonic gates.

14. The computer-readable storage medium of claim 13, wherein the stored instructions comprise further stored instructions that, when executed, cause the at least one processor to:
instruct the second optimizer circuit to execute the design algorithm using the plurality of parameters of the target model to instantiate a plurality of photonic logic cells forming a nonlinear photonic super-circuit that includes the photonic super-gate and a nonlinear thresholder circuit coupled to an output port of the photonic super-gate, the nonlinear photonic super-circuit emulating nonlinear operations of the photonic circuit having the plurality of cascaded photonic gates.

15. The computer-readable storage medium of claim 14, wherein the stored instructions comprise further stored instructions that, when executed, cause the at least one processor to:
instruct the nonlinear thresholder circuit to correct one or more accumulative errors in a first photonic output signal generated by the photonic super-gate and output at the output port of the photonic super-gate; and
instruct the nonlinear thresholder circuit to generate a second photonic output signal at an output port of the nonlinear photonic super-circuit, wherein the second photonic output signal is an error-free version of the first photonic output signal.

16. The computer-readable storage medium of claim 13, wherein the stored instructions comprise further stored instructions that, when executed, cause the at least one processor to:
instruct the first optimizer circuit to generate, based on the set of photonic input signals and the set of one or more photonic output signals, a library of cells for the photonic super-gate.

17. The computer-readable storage medium of claim 13, wherein the stored instructions comprise further stored instructions that, when executed, cause the at least one processor to:
instruct the second optimizer circuit to execute the design algorithm by executing an optimization algorithm using the plurality of parameters of the target model to instantiate a plurality of photonic logic cells that form the photonic super-gate.

18. The computer-readable storage medium of claim 13, wherein the stored instructions comprise further stored instructions that, when executed, cause the at least one processor to:
instruct the second optimizer circuit to execute the design algorithm by executing an inverse-design algorithm using the plurality of parameters of the target model to instantiate a plurality of photonic logic cells that form the photonic super-gate.

19. A method performed by an emulator circuit, the method comprising:
generating, by a first modeling circuit of the emulator circuit, a plurality of parameters of a physical model for a photonic circuit having a plurality of cascaded photonic gates, based on a set of photonic input signals and a set of one or more photonic output signals that are defined in accordance with a truth table of the photonic circuit;
estimating, by a first optimizer circuit of the emulator circuit coupled to the first modeling circuit, a plurality of initial parameters of a target model for the photonic circuit based on the plurality of parameters of the physical model;
generating, by a second modeling circuit of the emulator circuit coupled to the first optimizer circuit, a plurality of parameters of the target model based on the plurality of initial parameters; and
executing, by a second optimizer circuit of the emulator circuit coupled to the second modeling circuit, a design algorithm on the plurality of parameters of the target model to instantiate a photonic super-gate emulating operations of the photonic circuit having the plurality of cascaded photonic gates.

20. The method of claim 1, further comprising:
executing, by the second optimizer circuit, the design algorithm using the plurality of parameters of the target model to instantiate a plurality of photonic logic cells forming a nonlinear photonic super-circuit that includes the photonic super-gate and a nonlinear thresholder circuit coupled to an output port of the photonic super-gate, the nonlinear photonic super-circuit emulating nonlinear operations of the photonic circuit having the plurality of cascaded photonic gates.
